(19) United States
(12) Patent Application Publication
(10) Pub. No.: US 2021/0194669 A1
(43) Pub. Date: Jun. 24, 2021

(54) CRYPTOGRAPHIC PROCESSING METHOD, ASSOCIATED ELECTRONIC DEVICE AND COMPUTER PROGRAM

(71) Applicant: IDEMIA France, Courbevoie (FR)

(72) Inventors: Alberto BATTISTELLO, Courbevoie (FR); Laurent CASTELNOVI, Courbevoie (FR); Thomas CHABRIER, Courbevoie (FR)

(21) Appl. No.: 17/120,952

(22) Filed: Dec. 14, 2020

(30) Foreign Application Priority Data
Dec. 20, 2019 (FR) 1915071

(51) Int. Cl. H04L 9/00; G09C 1/00

(52) U.S. Cl. CPC H04L 9/008; H04L 2209/16; G09C 1/00

(57) ABSTRACT

A cryptographic processing method transforming an input byte into an output byte comprises the following steps:
converting a plurality of words, each comprising at least one bit of the input byte, into input cryptograms by application, to each of said words, of a homomorphic encryption function from a first group to a second group provided with an operation;
obtaining output cryptograms as a function of the input cryptograms, this obtaining step including at least one processing during which said operation is applied to two intermediate cryptograms, this processing producing a cryptogram that is an image by the homomorphic encryption function of a word including a Boolean logic combination of two bits comprised respectively in two words that are arguments, for the homomorphic encryption function, of said two intermediate cryptograms;
determining bits of the output byte by applying respectively to the output cryptograms, an inverse function of the homomorphic encryption function.

This application claims priority to FR Patent Application No. 1915071 filed Dec. 20, 2019, the entire contents of which are hereby incorporated by reference.

The present invention relates to the technical field of cryptography.

It relates more specifically to a cryptographic processing method, as well as an associated electronic device and computer program.

When a cryptographic algorithm is implemented by means of an item of software executed in an unsecure environment, particular measures must be taken to avoid a hacker being able to have access to secret data (for example, cryptographic keys) by simply taking control of this environment.

The search for techniques allowing to secure the implementation of a cryptographic algorithm in an unsecure environment is known under the name of white box cryptography.

The article “White Box Cryptography and an AES implementation”, by S. Chow et al., in Post-Proceedings of the 9th Annual Workshop on Selected Areas in Cryptography (SAC'02), 15-16 Aug. 2002 proposes, for example, a technique for producing AES-type algorithms, each adapted to a particular cryptographic key.

In solutions generally proposed within this scope, the cryptographic algorithm is broken down into a series of basic processing events and look-up tables associated respectively with these basic processing events, are used to handle masked data.

These solutions particularly take up a lot of memory, due to the use of these numerous look-up tables.

In this context, the invention proposes a cryptographic processing method transforming an input byte into an output byte, characterized by the following steps:
converting a plurality of words, each comprising at least one bit of the input byte, into input cryptograms by application, to each of said words, of a homomorphic encryption function from a first group to a second group provided with an operation;
obtaining output cryptograms as a function of the input cryptograms, this obtaining step including at least one processing during which said operation is applied to two intermediate cryptograms, this processing producing a cryptogram that is an image by the homomorphic encryption function of a word including a Boolean logic combination of two bits comprised respectively in two words that are arguments, for the homomorphic encryption function, of said two intermediate cryptograms;
determining bits of the output byte by applying respectively to the output cryptograms, an inverse function of the homomorphic encryption function.

The operation applied to the two intermediate cryptograms amounts to adding or multiplying corresponding words (in the sense of the homomorphic encryption function) and thus, with hardly any or no additional handling within the abovementioned processing, a Boolean logic combination of two respective bits of these corresponding words.

With the additional handlings (in addition to the application of the abovementioned operation) being limited, the number of necessary look-up tables is less important than in conventional solutions.

It can be provided that, for each intermediate cryptogram, the argument corresponding to this intermediate cryptogram via the homomorphic encryption function comprises a first bit and a second bit, the order (or position) of which is immediately greater than (i.e. immediately above) the first bit and which has a predefined value. In other words, each intermediate cryptogram is the image, by the homomorphic encryption function, of a word comprising a first bit and a second bit, the order (or position) of which is immediately greater than (i.e. immediately above) that of the first bit, and which has this predefined value.

The conversion step can be applied, for example, to words each comprising a first bit equal to one bit of the input byte and a second bit, the order (or position) of which is immediately greater than (i.e. above) the first bit and which has a predefined value (such as the zero value).

The method can possibly comprise a step of determining, by random drawing, a binary word comprising at least one bit; the conversion step can, in this case, be applied to words each comprising said binary word and a given bit equal to one bit of the input byte. The bit having the lowest order (or position) coming from the binary word can thus for example be of order (or position) immediately greater than (i.e. immediately above) the order (or position) of the given bit, or be only of order (position) greater than (i.e. above) the order (or position) of the given bit (a bit of predefined value, for example of zero value, could in this latter case be inserted between said binary word and the given bit equal to the bit of the input byte).

The conversion step can be applied, in practice, to words, each comprising a plurality of bits of the input byte.

The abovementioned processing can comprise, in certain cases, the reading of an associated cryptogram, in a look-up table, to the result of the operation applied to the two intermediate cryptograms. This reading provides, for example, the image cryptogram (by the homomorphic encryption function) of a word obtained by a particular handling (such as a shifting of one bit to the right) from an argument (in the sense of the homomorphic encryption function) of said result of the operation.

The conversion step can further comprise a step of applying the operation to an input cryptogram and to a mask. This mask is, for example, determined randomly beforehand and stored in a storage module.

The obtaining step can comprise a step of combining two input cryptograms by a recombination function according to the Chinese remainder theorem. The cryptograms thus combined can be processed simultaneously, which reduces the number of operations of the second group to be carried out.

The operation is, for example, a multiplication; the second group can be, in practice, a finite field. The second group can moreover be distinct from the first group.

The invention also proposes an electronic device comprising a processor and a memory storing computer program instructions designed to implement the following steps when these instructions are executed by the processor:
converting a plurality of words, each comprising at least one bit of an input byte, into input cryptograms by application, to each of said words, of a homomorphic encryption function from a first group to a second group provided with an operation;
obtaining output cryptograms as a function of the input cryptograms, this obtaining step including at least one processing event during which said operation is applied to two intermediate cryptograms, this processing event producing a cryptogram that is an image by the homomorphic encryption function of a word including a Boolean logic combination of two bits comprised respectively in two words that are arguments, for the homomorphic encryption function, of said two intermediate cryptograms;
determining bits of an output byte by applying respectively to the output cryptograms, an inverse function of the homomorphic encryption function.

The invention also proposes a computer program comprising instructions designed to implement the following steps when these instructions are executed by a processor:
converting a plurality of words, each comprising at least one bit of an input byte, into input cryptograms by application, to each of said words, of a homomorphic encryption function from a first group to a second group provided with an operation;
obtaining output cryptograms according to the input cryptograms, this obtaining step including at least one processing event during which said operation is applied to two intermediate cryptograms, this processing event producing a cryptogram that is an image by the homomorphic encryption function of a word including a Boolean logic combination of two bits comprised respectively in two words that are arguments, for the homomorphic encryption function, of said two intermediate cryptograms;
determining bits of an output byte by applying respectively to the output cryptograms, an inverse function of the homomorphic encryption function.

The invention further proposes a computer-readable non-transitory storage medium storing such instructions.

Of course, the different features, variants and embodiments of the invention can be associated with one another according to various combinations insofar as they are not incompatible or exclusive with/from one another.

In addition, various other features of the invention emerge from the following description, made in reference to the drawings which illustrate non-limiting embodiments of the invention, and where:

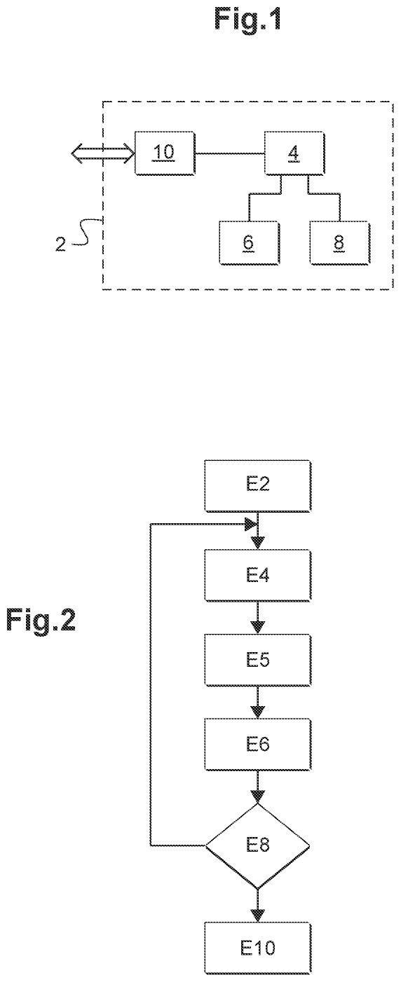

FIG. 1 schematically represents an electronic device according to the invention, and

FIG. 2 is a flowchart showing the main steps of a method according to the invention.

FIG. 1 schematically represents an electronic device 2 comprising a processor 4 (for example, a microprocessor), a storage module 6, a random access memory 8 and a communication module 10.

The storage module 6 stores computer program instructions designed to implement a cryptographic processing method such as that described below in reference to FIG. 2 when these instructions are executed by the processor 4. The storage module 6 is, for example, in practice, a hard disk or a non-volatile memory (possibly rewritable).

The random access memory 8 can itself store at least some of the elements (in particular, bytes and cryptograms) handled during the various processing events carried out during the method of FIG. 2.

The communication module 10 is connected to the processor 4 so as to allow the processor 4 to receive data coming from another electronic device (not represented) and/or to transmit data to another electronic device (not represented).

According to an embodiment possibility, the computer program instructions stored in the storage module 6 have, for example been received (for example, from a remote computer) during an operating phase of the electronic device 2 prior to the method described below in reference to FIG. 2.

The invention is applied in particular when the electronic device 2 is not secure and that a hacker can therefore have access to the internal operation of the electronic device 2, and thus to the processing events carried out by the processor 4 and to the data handled during these processing events. (It is the scope of white box cryptography mentioned in the introduction).

FIG. 2 shows the main steps of a cryptographic processing method according to the invention. This cryptographic processing method is here implemented by the electronic device 2 (due to the execution of the computer program instructions stored in the storage module 6 as indicated above).

Such a method allows to transform an input byte I into an output byte O by means of

Boolean logic operations, as described, for example, in the article “A new combinational logic minimization technique with applications to cryptology”, by J. Boyar and R. Peralta, in International Symposium on Experimental Algorithms, Springer, Berlin, Heidelberg, 2010.

The bits of the input byte I are denoted I. This input byte I is written therefore in binary form:

(I_{N-1}∥I_{N-2}∥ . . . ∥I₁∥I₀), where ∥ is the concatenation operator, N is the number of bits of the input byte I (here: N=8), I_{N-1} the bit of highest order (or most-significant bit) of the input byte I and I₀ the bit of lowest order (or least-significant bit) of the input byte I. (In other applications, N can have a value different from 8, for example N=128 in the scope of an AES algorithm. N is, for example, comprised between 8 and 256).

The method of FIG. 2 starts by a step E2 in which the processor 4 converts a plurality of words Mᵢ into a respective plurality of input cryptograms Cᵢ by means of a homomorphic encryption function B.

Each of the words Mᵢ comprises at least one bit of the input byte I and constitutes an element of a first (finite) group G. This first group G is an additive group in the example described here, but could in a variant, be a multiplication group, as explained again below.

In practice, it can be provided that each word Mᵢ comprises a first bit equal to one bit Iⱼ of the input byte I and a second bit, the order of which is immediately greater than the first bit and which has a predefined value (here: 0; in a variant: 1).

According to the embodiment described here, each word Mᵢ comprises precisely (for example, as a low-order bit) one bit I, of the input byte I.

The conversion step E2 therefore uses here N words Mᵢ respectively associated with N bits Iᵢ of the input byte I.

The abovementioned predefined value equaling here 0, each word Mᵢ is written in the present case:

Mᵢ=(0∥Iᵢ).

Each word Mᵢ is written in this case on 2 bits.

Furthermore, it could be provided to complete each word Mᵢ by random bits sᵢ (determined, for example, randomly during the step E2). In this case, each word Mᵢ is written:

Mᵢ=(s_{σ}∥ . . . ∥s₁∥0∥Iᵢ), where σ is the number of random bits used.

In a variant, each word Mᵢ could be constructed as follows (the bit 0 could be inserted during the cleaning step E4 described below):

Mᵢ=(s_{σ}∥ . . . s₁∥Iᵢ).

According to another embodiment which can be considered, each word Mᵢ could comprise several bits Iⱼ of the input byte I. Thus, each word Mᵢ could, for example, comprise two bits Iⱼ of the input byte I and be written:

Mᵢ=(0∥I₂ᵢ₊₁∥0∥I₂ᵢ).

In the latter case, the step E2 uses N/2 words Mᵢ.

The homomorphic encryption function B is a function from the first group G to a second group G′ provided with an operation (here referenced by the symbol “.”) and which can be distinct from the first group G.

The homomorphic character of the function B implies that, whatever the elements a and b within the first group G, B(a)·B(b)=B(a+b).

For example, as a homomorphic encryption function B, a modified Benaloh function is used, of the type:

B(a)=y^{a}u^{r} mod p,

where p is a prime number, y and u are integers comprised between 1 and p−1, and r is of the form r=2^{k} (k being greater than or equal to 2, preferably greater than or equal to the size in bits of the words Mᵢ applied at the input of the function B), r furthermore dividing the order of the second group G′. Functions of this type are described in the article “Dense probabilistic encryption”, Josh Benaloh, in Proceedings of the Workshop on selected areas of Cryptography, 1994. In this regard, it can be provided that the order of the number y is not equal to the order of the second group G′ divided by r. The length of the number p expressed in bits (that is log² p) is, for example, comprised between 4 bits and 32 bits (i.e. that, with the high-order bit at 1 for security reasons, p is, for example, comprised between 2³ and 2³²−1).

According to an embodiment possibility, thanks to the properties of the Benaloh function used here, different values of the number u can be used for the different applications of the homomorphic encryption function B to the different words Mᵢ.

The image values B(a) are therefore comprised between 1 and p−1 and the second group G′ is therefore here a finite group with (p−1) elements (the operation referenced “.” being the multiplication in (Z/pZ)*).

For example, words Mᵢ are used, having a length in bits equal to the length of the number p expressed in the form of bits (that is log² p, where log² is the base-2 logarithm). In the case where random bits are used as described above, thus the following may be taken as an example: σ=(log² p−1) or σ=(log² p−2).

It is noted that preferably r is selected, such that it divides (p−1).

In practice, the step E2 is, for example, implemented by means of at least one first look-up table T1, stored for example in the storage module 6.

This first look-up table stores, for each element a of the first group G (i.e. for each possible value of a), the value that is the image of this element a by the homomorphic encryption function B, i.e. the value B(a).

In this case, the step E2 comprises, for each word Mᵢ, the reading of the input cryptogram Cᵢ associated with this word Mᵢ in the first look-up table T1.

In a variant, it can be provided to use a plurality of first look-up tables T1ᵢ for the processing of different words Mᵢ, respectively.

Thus, in the case described here where N words Mᵢ is used, N first look-up tables Mᵢ can be used. The different first look-up tables T1ᵢ are, for example, formed by using different values of u in the formula defining the function B above (and/or different random bits s₁, . . . , s_{σ} in the variants where such random bits are used, as explained above).

In other words, in this case, each first look-up table T1ᵢ stores, for each element a of the first group G, the value y^{a}uᵢ^{r} mod p, the values of u, being different two-by-two for i varying from 0 to N−1.

In this case, the step E2 comprises, for each word Mᵢ of index i, the reading of the input cryptogram Cᵢ associated with this word Mᵢ in the first look-up table T1ᵢ of index i.

According to another variant which can be considered, the first look-up table T1 can directly convert a bit Iᵢ of the input byte I into the image B(Mᵢ) of the word Mᵢ (associated with this bit Iᵢ) by the homomorphic encryption function B. (As indicated above, the word Mᵢ can be of the form Mᵢ=(0∥Iᵢ), Mᵢ=(s_{σ}∥ . . . μs₁∥Iᵢ) or Mᵢ=(s_{σ}∥ . . . μs₁∥0∥Iᵢ).)

Also, in this case, several first look-up tables T1ᵢ can be used respectively for the different bits Iᵢ of the input byte I (the different first look-up tables T1ᵢ could be constructed with different random bits s₁, . . . , s_{σ} as explained above, when such random bits are used).

According to yet another variant, in the case where the words Mᵢ are of the form Mᵢ=(0∥I₂ᵢ₊₁∥0∥I₂ᵢ), the first look-up table T1 can convert a plurality of bits (here 2 bits I₂ᵢ₊₁, I₂ᵢ) of the input byte into the image B(Mᵢ) of the word Mᵢ (associated with these bits I₂ᵢ₊₁, I₂ᵢ) by the homomorphic encryption function B.

Also, in this case, several first look-up tables T1ᵢ can be used, respectively for the different bit sets (here bit pairs I₂ᵢ₊₁, I₂ᵢ) of the input byte I (the different first look-up tables T1ᵢ could be constructed with different random bits s₁, . . . , s_{σ}, as explained above, when such random bits are used).

According to another variant which can be considered, the first look-up table T1 can associate, with any byte (here octet) of the form e₇e₆ . . . e₀ (where eⱼ are bits of this byte), the value B(e₇∥e₆∥ . . . ∥e₁∥0∥e₀) or the value B_{e7 . . . e3} (e₂∥e₁∥0∥e₀), with B_{e7 . . . e3} the Benaloh function proposed above, wherein the number u is defined as a bit function e₇e₆ . . . e₃.

In this case, during step E2, for each bit Iᵢ of the input byte I, the processor 4 randomly determines a sequence of bits (here, a sequence of 7 bits) α₁, . . . , α₇ and reads, in the first look-up table T1, the input cryptogram Cᵢ associated with the byte (α₇∥ . . . ∥α₁∥Iᵢ) comprising the bits α₁, . . . , α₇ randomly determined and the bit Iᵢ in question of the input byte I.

After step E2, the method of FIG. 2 comprises a loop (steps E4 to E8) which allows a predetermined number of passages in steps E4, E5 and E6.

These successive passages in steps E4, E5 and E6, described below aim, at each passage, to carry out one of the Boolean logic operations provided as indicated above, each of these Boolean logic operations needing to be applied to a bit I, of the input byte I (for the first Boolean logic operations carried out), or to an intermediate bit aᵢ obtained by a preceding Boolean operation, by furthermore possibly using predefined bits (such as bits of a cryptographic key that is sought to be applied, by means of a cryptographic algorithm, to the input byte I).

As explained now, each of these Boolean logic operations is carried out by means of an application of the operation “.” (operation of the second group G′) to cryptograms Aᵢ (each of these cryptograms Aᵢ being either an input cryptogram Cᵢ obtained in step E2, or an intermediate cryptogram derived from the input cryptograms Cᵢ by previous operations).

Thus, to implement a Boolean logic operation between a first bit aᵢ and a second bit bᵢ, the processor 4 carries out in step E5, the operation Aᵢ·Bᵢ between the image, by the homomorphic encryption function B, of a first word, here (0∥aᵢ), comprising the first bit aᵢ, and the image, by the homomorphic encryption function B, of a second word, here (0∥bᵢ), comprising the second bit bᵢ (i.e. Aᵢ=B(0∥aᵢ) and Bᵢ=B(0∥bᵢ)).

Each intermediate cryptogram is thus the image, by the homomorphic encryption function B, of a word comprising a given bit aᵢ; bᵢ (defining what this word represents) and another bit, the order of which is immediately greater than that of the given bit (i.e. the position of which is immediately above that of the given bit), and which has the predefined value. As explained below, a cleaning step is implemented if needed to ensure this.

As already indicated, the images Aᵢ, Bᵢ involved in this operation are either input cryptograms C, obtained in step E2, or the results of previous passages in steps E4 to E6, or cryptograms stored in the storage module 6 (and which represent respectively the abovementioned predefined bits, for example bits of a cryptographic key).

Indeed, the inventors have noted that, thanks to the homomorphism property, regardless of aᵢ and bᵢ:

B(0∥aᵢ).B(0∥bᵢ)=B[(0∥aᵢ)+(0∥bᵢ)]=B(aᵢ AND bᵢ∥aᵢ XOR bᵢ),

where AND and XOR are respectively the Boolean logic operations “and” and “exclusive or”.

(This observation remains valid in the variant described above where the words Mᵢ comprise several bits Iⱼ of the input byte I as a result of:

B(0∥aᵢ₊₁∥0∥aᵢ).B(0∥bᵢ₊₁∥0∥bᵢ)=B(aᵢ₊₁ ANDbᵢ₊₁∥aᵢ₊₁X0Rbᵢ₊₁∥aᵢANDbᵢ∥aᵢX0Rbᵢ). Likewise, this observation remains valid in the variants where the cryptograms are generated in step E2 by using high-order random bits, since these high order bits do not participate in the operations between low-order bits, which are carried out as has just been described.

The processing event to be applied (possibly) to the product thus obtained is explained below, to select, as the value to be used following the processing event (depending on the Boolean logic operation to be carried out by the current passage in steps E4 to E6), either the value (aᵢ AND bᵢ, or the value (aᵢ XOR bᵢ).

The processing of step E5 thus produces a cryptogram Aᵢ.Bᵢ=B(aᵢ AND bᵢ∥aᵢ XOR bᵢ) which is the image by the homomorphic encryption function B of a word including the Boolean logic combination (here by “and” or by “exclusive or”) of two bits aᵢ, bᵢ comprised respectively in two words (0∥aᵢ) and (0∥bᵢ) that are arguments, for the homomorphic encryption function B, of said two intermediate cryptograms Aᵢ, Bᵢ.

It is noted that the bits aᵢ, bᵢ are never handled as such, but always by means of the operation of the second group G′ (referenced here: “.”) on the intermediate cryptograms Aᵢ, Bᵢ which represent these bits aᵢ, bᵢ.

According to the logic operation to be carried out (on the bits aᵢ, bᵢ) during the current passage in steps E4 to E6, the processor 4 possibly moreover implements additional steps, namely here a step E4 of cleaning the cryptograms Aᵢ, Bᵢ (corresponding respectively to bits aᵢ, bᵢ to be processed) and a step E6 of formatting the cryptogram Aᵢ·Bᵢ obtained in step E5.

Indeed, in certain cases, no additional step E4, E6 is necessary; the cryptograms Aᵢ, Bᵢ can be directly processed in step E5 and the cryptogram produces Aᵢ·Bᵢ obtained can be directly used for subsequent processing, i.e. either to carry out a new Boolean operation in step E5, or to generate the output byte in step E10 (described below).

In the example described here, no processing is implemented in additional steps E4, E6 when the Boolean logic operation to be carried out by the current iteration (i.e. the current passage in steps E4 to E6) is an “exclusive or” operation.

Indeed, as explained above, the low-order bit of the argument (aᵢ AND bᵢ∥aᵢ XOR bᵢ) of the cryptogram Aᵢ·Bᵢ in this case equals (aᵢ XOR bᵢ) and the cryptogram Aᵢ·Bᵢ obtained in step E5 can therefore be used as representative of a new intermediate bit, equal to aᵢ XOR bᵢ, during a subsequent passage to step E5 (or during the generation of the output byte in step E10).

Furthermore, it is noted in this regard, that in the example described here, it is not necessary, before carrying out step E5 to carry out an “exclusive or” Boolean logic operation, to ensure that the arguments of the cryptograms Aᵢ, Bᵢ processed during this step E4 are of the form (0∥aᵢ), (0∥bᵢ). Indeed, whatever the values of x and of y, (x∥aᵢ)(y ∥bᵢ)=(z∥aᵢ XOR bᵢ , where z itself depends on x and y.

However, when the current iteration of the steps E4 to E6 aims to carry out an “and” Boolean logic operation, the following processing events must be applied to the cryptograms Aᵢ, Bᵢ, Aᵢ·Bᵢ:
a cleaning step E4, prior to step E5, which aims to ensure that, for each cryptogram Aᵢ, Bᵢ to be processed, the argument corresponding to this cryptogram comprises a first bit and a second bit, the order of which is immediately greater than the first bit, and which has the predefined value, i.e. that this argument is of the form (0∥aᵢ), (0∥bᵢ), where, as above, aᵢ and bᵢ are the bits for which the “and” Boolean operation is sought to be calculated, and which are respectively represented by the cryptograms Aᵢ and Bᵢ;
a formatting step E6, subsequent to step E5, which allows to replace the bit (aᵢ AND bᵢ) as the low-order bit of the cryptogram representing this new intermediate bit (aᵢ AND bᵢ), so as to be able to use this cryptogram as described above during a subsequent passage in steps E4 to E6.

The cleaning step E4 therefore aims to keep any cryptogram Aᵢ, Bᵢ which can be written B(0∥dᵢ), i.e. any cryptogram which is the image by the homomorphic encryption function of a word of which the high-order bit has the predefined value (here 0), and to transform into a new cryptogram B(0∥dᵢ) any cryptogram Aᵢ, Bᵢ which can be written B(1∥dᵢ), i.e. any cryptogram which is the image by the homomorphic encryption function of a word of which the high-order bit does not have the predefined value.

The cleaning step E4 is, for example, implemented by means of a second look-up table T2 which, for any dᵢ, associates to any cryptogram of the form B(0∥dᵢ) a cryptogram of the form B(0∥dᵢ), possibly identical to the cryptogram input to the second look-up table T2, and to any cryptogram of the form B(1∥dᵢ) a cryptogram of the form B(0∥dᵢ).

This second look-up table T2 is, for example, stored in the storage module 6.

In this case, when it is sought to process by the Boolean logic operation in question (here, “and”) a bit aᵢ represented at the input by a cryptogram Aᵢ and a bit bᵢ represented at the input by a cryptogram Bᵢ, the processor 4 reads in the cleaning step E4, a cryptogram A′ᵢ associated with the cryptogram Aᵢ in the second look-up table T2, and a cryptogram B′ᵢ associated with the cryptogram Bᵢ in the second look-up table T2.

The cryptograms A′ᵢ and B′ᵢ thus obtained at the output of step E4 are those used for the processing by the operation “.” during step E5 as described above.

The formatting step E6 aims, as indicated above, to transform the cryptogram B(aᵢ AND bᵢ∥aᵢ XOR bᵢ) (obtained by means of step E5 as indicated above) into a cryptogram B(x∥aᵢ AND bᵢ), where x is any bit.

In other words, the formatting step E6 amounts to apply to the cryptogram in question, the inverse of the homomorphic encryption function, to shift the word obtained by one bit to the right, and to apply again the homomorphic encryption function.

In practice, the formatting step E6 can be implemented by means of a third look-up table T3 which to any cryptogram of the form B(dᵢ∥zᵢ) (i.e. to any cryptogram corresponding to an argument with a high-order bit dᵢ via the homomorphic encryption function B) associates a cryptogram of the form B(x∥dᵢ) (i.e. a cryptogram corresponding, via the homomorphic encryption function B, to an argument with a low-order bit equal to dᵢ).

This third look-up table T3 is, for example, stored in the storage module 6.

In this case, at the formatting step E6, the processor 4 reads, in the third look-up table T3, the cryptogram associated with the cryptogram obtained in step E5, the cryptogram read being used to represent the new intermediate bit (aᵢ AND bᵢ) in the further processing.

After the formatting step E6, the processor 4 determined in step E8 if the processing carried out involves at least one other Boolean logic operation (implemented here by means of the application of the operation “.” to the cryptograms). It is reminded that the processor 4 is programmed to produce a sequence of Boolean logic operations, as described, for example, in the abovementioned article “A new combinational logic minimization technique with applications to cryptology”.

If at least one Boolean logic operation remains to be carried out, the method loops to step E4 for the implementation of a new iteration of steps E4 to E6.

If all the Boolean logic operations have been carried out, the method continues in step E10 now described.

In step E10, the processor 4 generates the output byte O based on intermediate cryptograms obtained during preceding passages through steps E4 to E6 and which represent the different bits Oᵢ of the output byte O.

The intermediate cryptograms used as an output cryptogram C′ᵢ, i.e. to represent the bits Oᵢ of the output byte O, are determined according to the sequence of Boolean logic operations that are sought to be implemented (each intermediate cryptogram representing an intermediate bit handled during this sequence of Boolean logic operations).

The processor 4 determines the bits Oᵢ of the output byte O by applying respectively to these output cryptograms C′ᵢ an inverse function B⁻¹ of the homomorphic encryption function B.

In practice, the application of this inverse function can be implemented by means of a fourth look-up table T4, stored for example in the storage module 6.

This fourth look-up table T4 stores, for each possible value Z for a cryptogram, the word B⁻¹(Z), i.e. the argument corresponding to Z via the homomorphic encryption function B.

The processor 4 determines in this case, each bit Oᵢ of the output byte O by reading, in the fourth look-up table T4, of the word B⁻¹(C′ᵢ) associated with the output cryptogram C′ᵢ in question, the bit Oᵢ of the output byte O being a predetermined bit (here, the low-order bit) of the word B⁻¹(C′ᵢ).

In a variant, the fourth look-up table T4 could directly associate, to each possible value Z for a cryptogram, the low-order bit of the word B⁻¹(Z) that is the argument corresponding to this value Z via the homomorphic encryption function B.

Also, according to another variant, the first look-up table T1 could be used by the processor 4 to apply the inverse function B⁻¹ to the output cryptograms C′ᵢ.

In the example which has just been described, the first group G is an additive group using a Benaloh-type cryptosystem to define the homomorphic encryption function B.

Still in the case of a first additive group, as a variant, a Paillier-type cryptosystem can be used, as introduced in the article, “Public-key cryptosystems based on composite degree residuosity classes”, Pascal Paillier, in International Conference on the Theory and Application of Cryptographic Techniques, Springer, Berlin, Heidelberg, 1999.

According to another variant, the first group G can be a multiplication group.

In the scope of this variant, for example a homomorphic encryption function is used (referenced E in this variant) based on an EIGamal-type cryptosystem, described in the article, “A Public Key Cryptosystem and a Signature Scheme Based on Discrete Logarithms”, Taher ElGamal, in Crypto, Springer, 1984.

Thanks to the homomorphism property of this type of encryption function, regardless of the bits a, b: E(1∥a)·E(1∥b)=E(a XOR b∥a AND b); therefore, either of the two “and” and “exclusive or” Boolean logic operations can also be carried out in this variant, by means of an operation (here, also multiplicative) within the second group G′.

According to another variant, which can possibly be combined with those described above, the cryptograms handled are masked by a random mask t (here, multiplicative). This random mask is, for example, determined (by random drawing) during a phase for preparing the electronic device 2 and stored in the storage module 6.

To do this, during step E2, the processor applies the random mask t to the cryptograms Cᵢ by means of the operation “. ”. The following steps are thus applied to the cryptogram thus masked, namely t·Cᵢ.

According to an embodiment possibility, a plurality of random masks tᵢ (a priori distinct two-by-two) can be respectively applied to the different cryptograms Cᵢ produced during step E2.

In the two cases, the application of the mask t, tᵢ can be carried out, at the same time as the application of the homomorphic encryption function B, by means of the first look-up table T1. In other words, the first look-up table T1 stores in this case, for each possible value within the first group G, the associated cryptogram t·B(a).

The other look-up tables T2, T3, T4 are moreover adapted (before their storage in the storage module 6) to consider the mask applied. It can be provided in this case that second and third look-up tables T2, T3 are provided respectively for each Boolean operation implemented by means of the operation “.” in order to consider the mask t used.

Now, another variant is described according to which the input cryptograms Cᵢ are combined two-by-two by means of a recombination function according to the Chinese Remainder Theorem.

In this case, certain cryptograms (for example, those corresponding to the even-order bits of the input byte I, these cryptograms being referenced due to this, C₂ᵢ) are obtained as indicated above by applying the homomorphic encryption function B, having values in the second group G′ with (p−1) elements, to the corresponding word (0∥I₂ᵢ).

Other cryptograms (for example, those corresponding to the odd-order bits of the input byte, these cryptograms being referenced due to this, C₂ᵢ₊₁) are obtained by applying another homomorphic encryption function B′, having values in a third group G″ with (q−1) elements, to the corresponding word (0∥I₂ᵢ₊₁), with q, a prime number different from p.

The function B′ is, for example, defined by: B′(b)=y^{b}·u^{r} mod q.

The input cryptograms are thus combined two-by-two by means of a recombination function according to the Chinese Remainder Theorem (CRT). Here, the input cryptograms C₂ᵢ and C₂ᵢ₊₁ are combined as follows:

Aᵢ=CRT(C₂ᵢ, C₂ᵢ₊₁)=C₂ᵢ·q·i_{q}+C₂ᵢ₊₁·p·iₚ

where iₚ and i_{q} are such that q·i_{q}=1 mod p and p·iₚ=1 mod q (and q·i_{q}=0 mod q and p·iₚ=0 mod p).

The cryptograms Aᵢ obtained by this combination are those which are handled during the successive passages through steps E4 and E6.

Thus, the product Aᵢ.Bᵢ of two cryptograms Aᵢ, Bᵢ (Aᵢ representing the cryptograms X and X′: Aᵢ=CRT(X, X′) and B, representing the cryptograms Y and Y′: Bᵢ=CRT(Y, Y′)) allows to carry out operations on the two bits represented by each of these cryptograms Aᵢ, Bᵢ.

Indeed: Aᵢ·Bᵢ mod p=(X·q·i_{q}+X′·p·iₚ)·(Y·q·i_{q}+Y′·p·iₚ) mod p=X·Y.

Likewise: Aᵢ·Bᵢ mod q=(X·q·i_{q}+X′·p·iₚ)·(Y·q·i_{q}+Y′·p·iₚ) mod q=X′·Y′.

Thus, the products X·Y and X′·Y′ can be found (corresponding to those obtained in step E5 in the embodiment described above) by determining respectively the modulo-p remainder and the modulo-q remainder of the product Aᵢ·Bᵢ.

1. Cryptographic processing method transforming an input byte into an output byte, the method comprising the following steps:
converting a plurality of words, each comprising at least one bit of the input byte, into input cryptograms by application, to each of said words, of a homomorphic encryption function from a first group to a second group provided with an operation;
obtaining output cryptograms as a function of the input cryptograms, this obtaining step including at least one processing event during which said operation is applied to two intermediate cryptograms, this processing event producing a cryptogram that is an image by the homomorphic encryption function of a word including a Boolean logic combination of two bits comprised respectively in two words that are arguments, for the homomorphic encryption function, of said two intermediate cryptograms;
determining bits of the output byte by applying respectively to the output cryptograms, an inverse function of the homomorphic encryption function,
wherein, for each intermediate cryptogram, the argument corresponding to this intermediate cryptogram via the homomorphic encryption function comprises a first bit and a second bit, the order of which is immediately greater than the first bit and which has a predefined value.

2. Method according to claim 1, wherein the conversion step is applied to words, each comprising a first bit equal to a bit of the input byte and a second bit, the order of which is immediately greater than the first bit and which has said predefined value.

3. Method according to claim 1, comprising a step of determining, by random drawing, a binary word comprising at least one bit, wherein the conversion step is applied to words each comprising said binary word and a given bit equal to a bit of the input byte.

4. Method according to claim 1, wherein the converting step is applied to words each comprising a plurality of bits of the input byte.

5. Method according to claim 1, wherein the processing event comprises the reading of a cryptogram associated, in a look-up table, to the result of the operation applied to the two intermediate cryptograms.

6. Method according to claim 1, wherein the converting step comprises a step of applying the operation to an input cryptogram and to a mask.

7. Method according to claim 1, wherein the obtaining step comprises a step of combining two input cryptograms by a recombination function according to the Chinese Remainder Theorem.

8. Method according to claim 1, wherein the operation is a multiplication and wherein the second group is a finite field.

9. Cryptographic processing method transforming an input byte into an output byte, the method comprising the following steps:
converting a plurality of words, each comprising at least one bit of the input byte, into input cryptograms by application, to each of said words, of a homomorphic encryption function from a first group to a second group provided with an operation;
obtaining output cryptograms as a function of the input cryptograms, this obtaining step including at least one processing during which said operation is applied to two intermediate cryptograms, this processing producing an cryptogram that is an image by the homomorphic encryption function of a word including a Boolean logic combination of two bits comprised respectively in two words that are arguments, for the homomorphic encryption function, of said two intermediate cryptograms;
determining bits of the output byte by applying respectively to the output cryptograms, an inverse function of the homomorphic encryption function,
wherein the conversion step is applied to words each comprising a first bit equal to a bit of the input byte and a second bit, the order of which is immediately greater than the first bit and which has a predefined value.

10. Method according to claim 9, comprising a step of determining, by random drawing, a binary word comprising at least one bit, wherein the converting step is applied to words, each comprising said binary word and a given bit equal to a bit of the input byte.

11. Method according to claim 9, wherein the converting step is applied to words, each comprising a plurality of bits of the input byte.

12. Method according to claim 9, wherein the processing comprises the reading of a cryptogram associated, in a look-up table, to the result of the operation applied to the two intermediate cryptograms.

13. Method according to claim 9, wherein the converting step comprises a step of applying the operation to an input cryptogram and to a mask.

14. Method according to claim 9, wherein the obtaining step comprises a step of combining two input cryptograms by a recombination function according to the Chinese Remainder Theorem.

15. Method according to claim 9, wherein the operation is a multiplication and wherein the second group is a finite field.

16. Electronic device comprising a processor and a memory storing computer program instructions designed to implement the following steps when these instructions are executed by the processor:
converting a plurality of words, each comprising at least one bit of the input byte, into input cryptograms by application, to each of said words, of a homomorphic encryption function from a first group to a second group provided with an operation;
obtaining output cryptograms as a function of the input cryptograms, this obtaining step including at least one processing during which said operation is applied to two intermediate cryptograms, the argument corresponding to each intermediate cryptogram via the homomorphic encryption function comprising a first bit and a second bit, the order of which is immediately greater than the first bit and which has a predefined value, said processing producing a cryptogram that is an image by the homomorphic encryption function of a word including a Boolean logic combination of two bits comprised respectively in two words that are arguments, for the homomorphic encryption function, of said two intermediate cryptograms;
determining bits of the output byte by applying respectively to the output cryptograms, an inverse function of the homomorphic encryption function.
